(19) United States
(12) Patent Application Publication
(10) Pub. No.: US 2018/0136342 A1
(43) Pub. Date: May 17, 2018

(54) RADIATION DETECTOR AND RADIATION DETECTION APPARATUS

(71) Applicant: CANON COMPONENTS, INC., Kodama-gun (JP)

(72) Inventors: Takehiro NAKAMURA, Saitama (JP); Tadashi Yasuhara, Saitama (JP); Ryoichi Fujino, Saitama (JP)

(21) Appl. No.: 15/809,435

(22) Filed: Nov. 10, 2017

(30) Foreign Application Priority Data
Nov. 16, 2016 (JP) 2016-222999

(51) Int. Cl. G01T 1/20

(52) U.S. Cl. CPC G01T 1/2006; G01T 1/2012

(57) ABSTRACT

A radiation detector includes: a wavelength conversion member that includes a fluorescent layer that emits fluorescent light when radiation enters this layer; an image sensor that converts the fluorescent light emitted from the fluorescent layer into an electric signal; and a wiring board where the image sensor is provided. The image sensor is provided on the surface on the lower side of the wiring board along one long side of the wiring board. One part of the wavelength conversion member is provided to be overlapped on the image sensor while the other part extends from the one long side of the wiring board so as not to be overlapped on the image sensor and the wiring board when viewed from radiation incident direction. The wiring board is disposed inclined so that the side where the wavelength conversion member extends can be disposed upward.

### CROSS-REFERENCE TO RELATED APPLICATIONS

This application is based upon and claims the benefit of priority of the prior Japanese Patent Application No. 2016-222999, filed on Nov. 16, 2016, the entire contents of which are incorporated herein by reference.

### BACKGROUND OF THE INVENTION

### Field of the Invention

The present invention relates to a radiation detector and a radiation detection apparatus. In particular, the present invention relates to a radiation detector that includes a fluorescent body that emits fluorescent light by incident radiation, and a photoelectric conversion element that performs photoelectric conversion of the fluorescent light, and to a radiation detection apparatus to which the radiation detector is applied.

### Description of the Related Art

Conventionally, there has been a radiation detector that includes a fluorescent body that is excited with incident radiation to emit fluorescent light (e.g. visible light), and a photoelectric conversion element that converts (performs photoelectric conversion of) the fluorescent light emitted from the fluorescent body into an electric signal. In such a radiation detector, it is preferable that the fluorescent body and the photoelectric conversion element be disposed close to each other in order to improve the efficiency of detecting radiation. Patent Documents 1 and 2 disclose radiation detectors that each include a photoelectric conversion element (a photodiode or element) and a fluorescent body (a wavelength conversion part or a scintillator) in an overlapped manner, wherein the photoelectric conversion element is disposed on a radiation source side (radiation incident side) and the fluorescent body is disposed on the opposite side. In such radiation detectors, radiation from the radiation source transmits through the photoelectric conversion element and reaches the fluorescent body.

However, in the configurations described in Patent Documents 1 and 2, the photoelectric conversion element is disposed on the path of the incident radiation. Consequently, the radiation from the radiation source is absorbed or scattered. Consequently, the dose of radiation reaching the fluorescent body decreases. When the radiation is absorbed by the photoelectric conversion element, noise is caused by ionization.
Patent Document 1: Japanese Laid-open Patent Publication No. 2016-95248
Patent Document 2: Japanese Laid-open Patent Publication No. 2006-329822

### SUMMARY OF THE INVENTION

In view of the above-described situation, the present invention has an object to increase the efficiency of detecting radiation while suppressing noise.

To achieve the object, the present invention includes: a wavelength conversion part that includes a fluorescent layer that emits fluorescent light when radiation enters the fluorescent layer; a photoelectric conversion part that converts the fluorescent light emitted from the fluorescent layer into an electric signal; and a wiring board where the photoelectric conversion part is provided, wherein the wavelength conversion part is provided on a surface on a side opposite to a side where the wiring board of the wavelength conversion part is provided, and is provided to include a portion overlapped on the photoelectric conversion part and a portion not overlapped on the photoelectric conversion part when viewed from a radiation incident direction.

### BRIEF DESCRIPTION OF THE DRAWINGS

FIG. 1 is a schematic exploded view showing a configuration example of a radiation detector;

FIG. 2 is an external perspective view showing the configuration example of the radiation detector;

FIG. 3 is an external perspective view showing a configuration example of a sensor substrate module;

FIG. 4 is a sectional view showing the configuration example of the radiation detector;

FIG. 5 is a schematic exploded view showing a configuration example of a radiation detector;

FIG. 6 is a sectional view showing the configuration example of the radiation detector;

FIG. 7 is a schematic exploded view showing a configuration example of a radiation detector;

FIG. 8 is a sectional view showing the configuration example of the radiation detector; and

FIG. 9 is a sectional view showing the configuration example of the radiation detection apparatus.

### DETAILED DESCRIPTION OF THE PREFERRED EMBODIMENTS

Hereinafter, each embodiment of the present invention is described in detail with reference to the drawings. A radiation detector according to each embodiment of the present invention is used with a predetermined side of this detector being oriented toward an inspection object and a radiation source. The radiation detector performs photoelectric conversion of radiation that has been emitted from the radiation source and has entered the predetermined side from a predetermined direction to generate a radiation image signal (radiation image data). For the sake of convenience of description, in each diagram, the three-dimensional directions of the radiation detector are indicated by respective arrows X, Y and Z. The X direction is the longitudinal direction of the radiation detector, and is a main-scan direction, for example. The Y direction is one short-hand direction of the radiation detector, and is a sub-scan direction, for example. The Z direction is the other short-hand direction of the radiation detector, and is the vertical direction (radiation incident direction), for example. With respect to the Z-direction, one side (one side that radiation enters) toward the radiation source in use and the inspection object is regarded as an upper side, and the opposite side is regarded as a lower side. The radiation detector according to each embodiment of the present invention detects radiation having entered from the upper side (radiation with the optical axis parallel to the vertical direction).

### First Embodiment of Radiation Detector

### Configuration Example

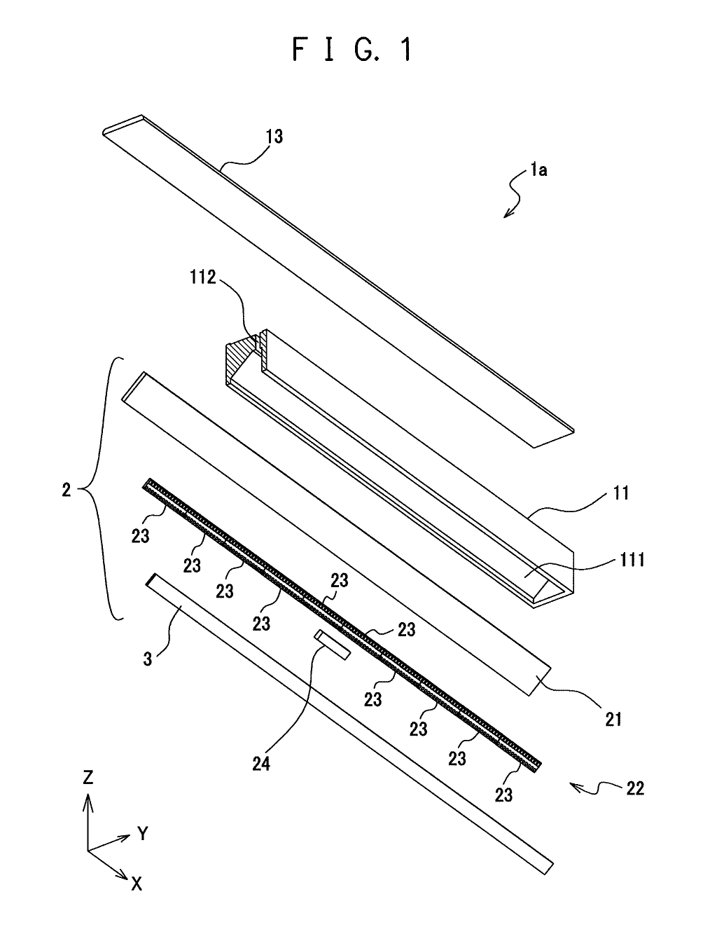

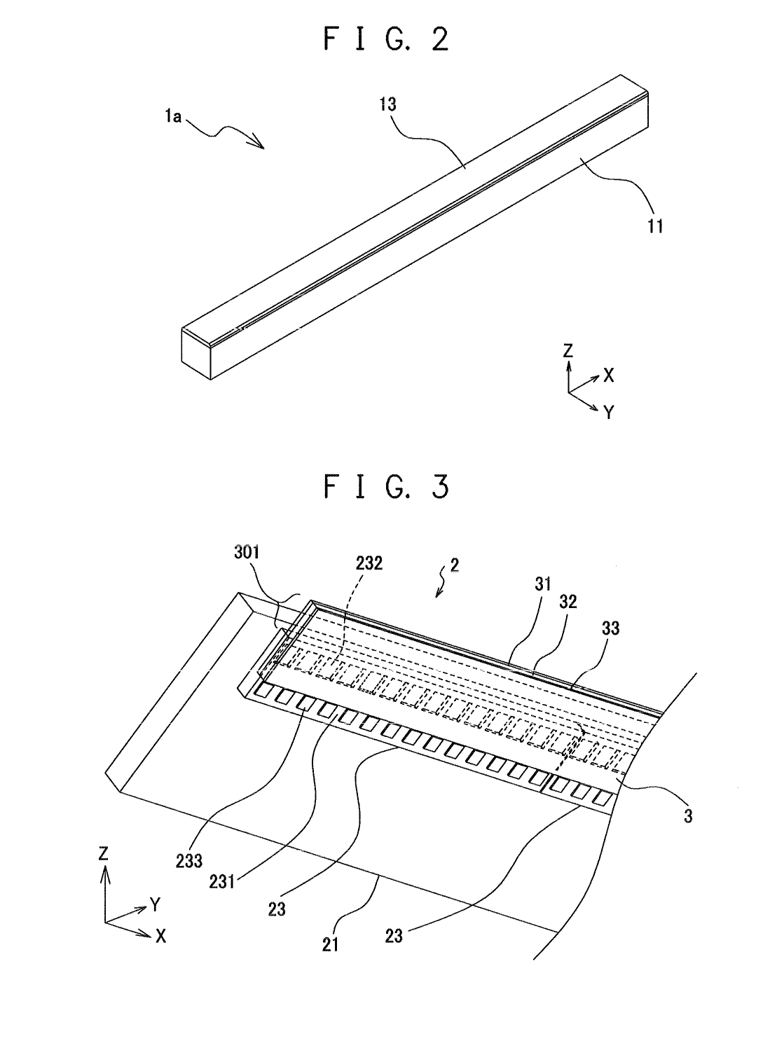

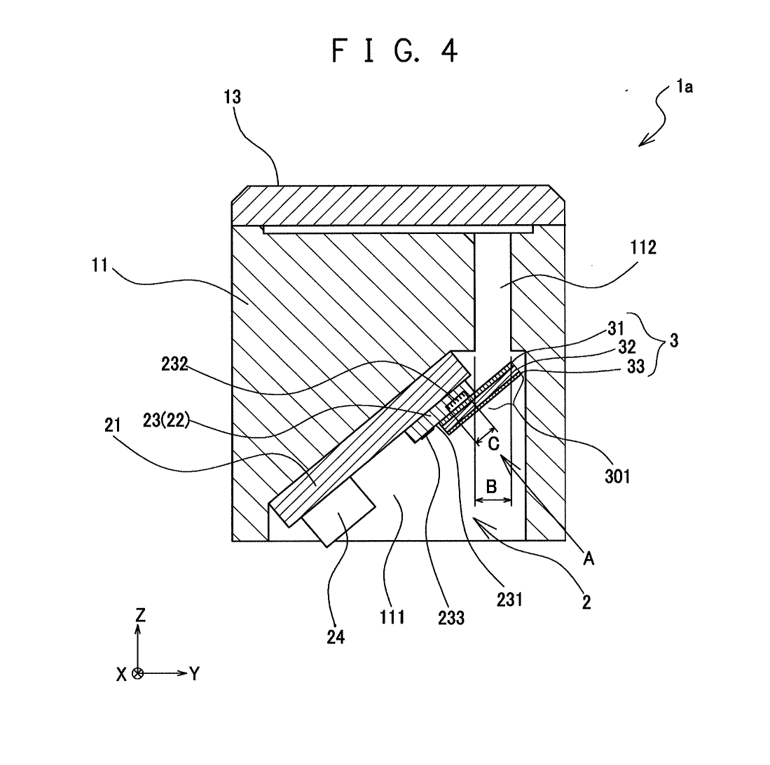

First, a configuration example of a radiation detector 1a according to a first embodiment is described with reference to FIGS. 1 to 4. FIG. 1 is an exploded view schematically showing the configuration example of the radiation detector 1a according to the first embodiment. FIG. 2 is an external perspective view schematically showing the configuration example of the radiation detector 1a according to the first embodiment. FIG. 3 is an external perspective view schematically showing a configuration example of a sensor substrate module 2 of the radiation detector 1a according to the first embodiment. FIG. 4 is a diagram schematically showing the configuration example of the radiation detector 1a according to the first embodiment, and is a sectional view taken along a plane perpendicular to the longitudinal direction. In FIG. 1, a state of a body frame 11 taken along a plane perpendicular to the longitudinal direction is shown to illustrate the internal configuration of the body frame 11. FIG. 3 shows a part of the sensor substrate module 2 in an enlarged manner, and indicates hidden lines behind a wavelength conversion part 3 with broken lines. As shown in FIGS. 1 to 4, the radiation detector 1a according to the first embodiment includes the body frame 11, the sensor substrate module 2, and a body cover 13.

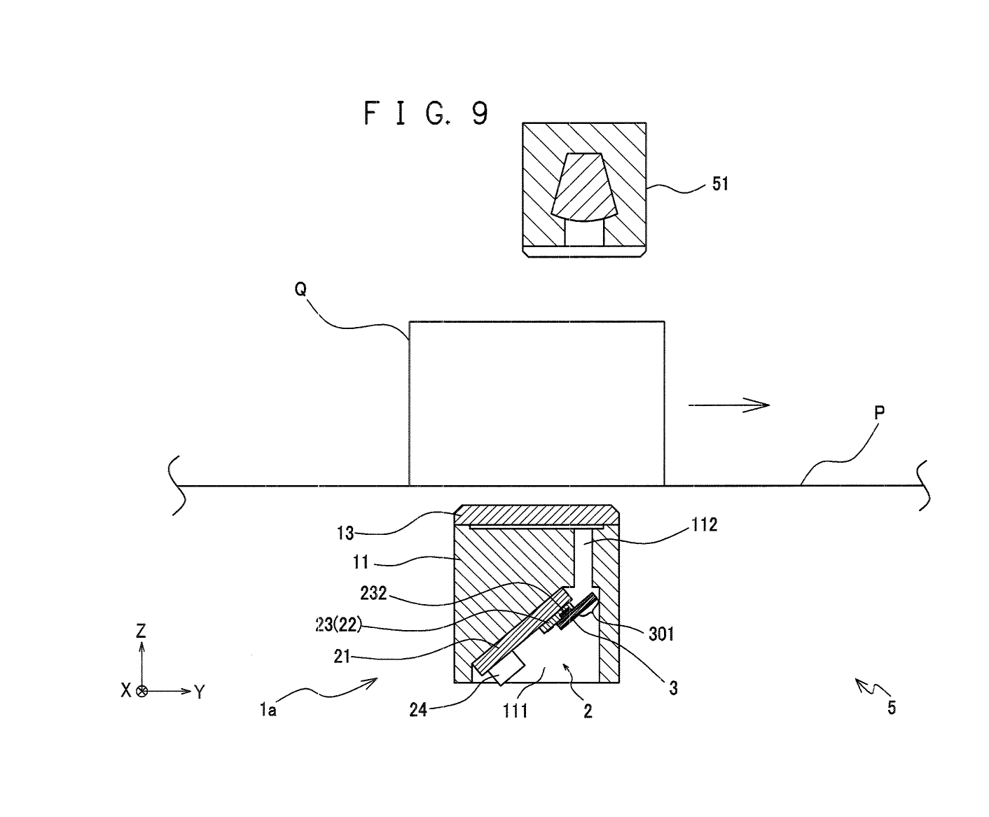

The body frame 11 is a casing of the radiation detector 1a. The body frame 11 has, for example, a substantially elongated rectangular parallelepiped shape, and is integrally formed of a material having a light blocking property. For example, polycarbonate (PC) colored in black can be applied as the material having a light blocking property. The body frame 11 includes a sensor substrate module housing portion 111 capable of housing the sensor substrate module 2. The sensor substrate module housing portion 111 is a groove or concave shape region that is elongated in the longitudinal direction of the body frame 11 and is open on the lower side (the side opposite to the side that radiation enters; the side opposite to the side oriented toward the inspection object Q and a radiation source 51 (see FIG. 9)). The body frame 11 is provided with a through-hole that allows the upper surface (on the side that radiation enters; the side oriented toward the inspection object Q and a radiation source 51) and the sensor substrate module housing portion 111 to communicate with each other. For the sake of convenience of description, the through-hole is called “frame through-hole 112”. The frame through-hole 112 is a path of radiation having entered the body frame 11. For example, a slit-shaped through-hole that is elongated in the longitudinal direction of the body frame 11 (the X-direction, or main-scan direction) to penetrate in the vertical direction (the Z-direction, or the direction of incident radiation) is applied as the frame through-hole 112.

The sensor substrate module 2 includes a wiring board 21, an image sensor 22 that is an example of a photoelectric conversion part provided on one surface of the wiring board 21, and a wavelength conversion member 3 that is an example of a wavelength conversion part provided to be overlapped on the image sensor 22.

The wiring board 21 of the sensor substrate module 2 has a shape elongated (for example, an elongated planar shape) in the longitudinal direction of the body frame 11. A wiring pattern, electrodes and the like (not shown) that are electrically connected to a plurality of later-described photodiode arrays 23 that form the image sensor 22 are provided on the one surface of the wiring board (not shown). The type (material or the like) of the wiring board 21 is not particularly limited. Any publicly known wiring board, such as a printed wiring board, may be adopted as the wiring board 21.

The image sensor 22 performs photoelectric conversion of fluorescent light emitted by a later-described fluorescent layer 32 of the wavelength conversion member 3, and generates and outputs a radiation image signal (radiation image data). In the embodiment of the present invention, an example where the plurality of photodiode arrays 23 are applied to the image sensor 22 is described. Each of the photodiode arrays 23 is an electronic component that includes a plurality of light receiving parts 232 and a predetermined number of electrodes 233, and generates and outputs an electric signal according to the intensity of light incident on the light receiving parts 232. For the sake of convenience of description, a surface on which the light receiving parts 232 and the electrodes 233 of the photodiode array 23 are provided is called “light receiving surface 231”. The light receiving surface 231 of the photodiode array 23 has an elongated shape. The plurality of light receiving parts 232 are provided at an end close to one side of the light receiving surface 231 in the short-hand direction in a manner linearly arranged in the longitudinal direction of the light receiving surface 231 so as to be parallel to one long side (side surface). The predetermined number of electrodes 233 are provided in a manner linearly arranged at an end close to the other side of the light receiving surface 231 in the short-hand direction (close to the side opposite to the side on which the plurality of light receiving parts 232 are provided). The plurality of photodiode arrays 23 are mounted on one side of the wiring board 21 in the short-hand direction (e.g. one end in the short-hand direction) in a manner linearly arranged in the longitudinal direction (main-scan direction). This allows the image sensor 22 to be formed. As described above, according to the embodiment of the present invention, the image sensor 22 is formed of the plurality of photodiode arrays 23 provided in the manner linearly arranged in the longitudinal direction (main-scan direction) of the wiring board 21.

The configuration of each of the photodiode arrays 23, which form the image sensor 22, is not limited to the configuration described above. Each of the photodiode arrays 23 may have any configuration that includes the plurality of light receiving parts 232 provided to be arranged linearly in a predetermined direction. The image sensor 22 is not limited to the configuration formed of the plurality of the photodiode arrays 23. That is, the image sensor 22 may have any configuration that includes the plurality of light receiving parts 232 one-dimensionally arranged in the longitudinal direction (main-scan direction).

The wavelength conversion member 3 is an example of the wavelength conversion part, and is a member that converts incident radiation into light having a wavelength range that the image sensor 22 can detect (visible light in the embodiment of the present invention). The wavelength conversion member 3 includes a substrate layer 31, the fluorescent layer 32 provided to be stacked on the substrate layer 31, and a reflection layer 33 provided to be stacked on the fluorescent layer 32, and has a configuration that is elongated and planar or sheet-shaped as a whole. A surface facing the substrate layer 31 between both the surfaces of the wavelength conversion member 3 serves as a radiation incident surface that radiation enters. A plate or sheet made of a transparent material (a material having a high transmittance of fluorescent light (visible light) emitted from the fluorescent layer 32), such as polyethylene terephthalate (PET), for example, is applied as the substrate layer 31. The fluorescent layer 32 is a layer of a material that is excited and emits visible light when radiation enters. For example, a fluorescent light material, such as gadolinium oxide sulfur (GOS), can be applied as the fluorescent layer 32. The reflection layer 33 is a layer made of a material that has a high reflectance of fluorescent light (visible light) emitted from the fluorescent layer 32 and has a high transmittance of radiation. For example, a material having a high reflectance of visible light and a high transmittance of radiation, such as aluminum, alumina or calcium carbonate, can be applied as the reflection layer 33.

The wavelength conversion member 3 is not limited to the configuration described above. The wavelength conversion member 3 may have any configuration that includes the fluorescent layer 32 that is excited with incident radiation to emit fluorescent light, and has an elongated shape in the longitudinal direction of the body frame 11 as a whole. For example, a monocrystal body or the like of gadolinium oxide sulfur (GOS), barium fluoride chloride:europium (BaFCl:Eu), lanthanum oxybromide: terbium (LaOBr:Tb), cesium iodide:thallium (CsI:Tl), calcium tungstate (CaWO₄), cadmium tungstate (CdWO₄), sodium iodide (NaI), cesium iodide (CsI) or the like can be applied as the fluorescent layer 32 of the wavelength conversion member 3. The substrate layer 31 is not limited to that of polyethylene terephthalate. Alternatively, any of various resin materials and glass can be applied as this layer. The reflection layer 33 may be made of any material that has a high reflectance of visible light and a high transmittance of radiation. In a case where the fluorescent layer 32 is made of a deliquescent material, it is preferable that the wavelength conversion member 3 include a protective layer that covers the fluorescent layer 32 so as to suppress the deliquescence of the fluorescent layer 32. For this case, a film that includes a single film or two or more stacked films among thermoplastic resin films usable as the protective layer, as required, can be used. For example, CPP/OPP, PET/OPP/LDPE, Ny/OPP/LDPE, CPP/OPP/EVOH, Saran-UB/LLDPE (here, Saran-UB is a biaxially stretched film made from vinylidene chloride/acrylic acid ester copolymer resin by Asahi Kasei Corp.), K-OP/PP, K-PET/LLDPE, K-Ny/EVA (here, K is a film coated with vinylidene chloride resin) and the like can be used. A deposited and polymerized film of polyparaxylylene may be adopted.

The plurality of photodiode arrays 23 are implemented linearly in the longitudinal direction (main-scan direction) of the wiring board 21, along one long side that is an edge part (in parallel to the long side), on one surface of the wiring board 21 (a surface that faces obliquely downward and is opposite to the surface that radiation enters). As described above, the plurality of photodiode arrays 23 are mounted at positions biased to one side, in the short-hand direction, of the one surface of the wiring board 21 along the one long side that is the edge part (in parallel to the one long side) in the manner linearly arranged in the longitudinal direction of the wiring board 21. For the sake of convenience of description, the long side nearer to the image sensor 22 (photodiode arrays 23) between the two long sides that are the edge parts of the wiring board 21 is called “adjacent long side”, and the long side that is a remote edge part is called “remote long side”. The photodiode arrays 23 are each provided so as to be oriented so that the side on which the plurality of light receiving parts 232 are provided can be closer to the adjacent long side and the side on which the electrodes 233 are provided can be apart from the adjacent long side. The distance between the photodiode arrays 23 and the adjacent long side of the wiring board 21 is not particularly limited. It is however preferable that the distance be as short as possible. The side surfaces of the photodiode arrays 23 may coincide with the position of the long side of the wiring board 21. Certain portions of the photodiode arrays 23 in the short-hand direction may be out of the one long side.

The wavelength conversion member 3 is provided to be overlapped on certain parts of the light receiving surfaces 231 of the photodiode arrays 23 so as to cover the light receiving parts 232 of the photodiode arrays 23. That is, the wavelength conversion member 3, which is an example of the wavelength conversion part, is provided on a surface of the photodiode arrays 23 opposite to the wiring board 21. Note that the wavelength conversion member 3 is provided at a position that is not overlapped on the electrodes 233 so as to avoid interference with bonding wire that connects the electrodes 233 of the photodiode arrays 23 to the wiring board 21. When viewed from the direction perpendicular to the surface of the wiring board 21, a part of the wavelength conversion member 3 in the short-hand direction is not overlapped on the wiring board 21 and the photodiode arrays 23, and extends from the adjacent long side of the wiring board 21 and the side surfaces of the photodiode arrays 23. For the sake of convenience of description, a portion of the wavelength conversion member 3 that extends from the adjacent long side of the wiring board 21 and the side surfaces of the photodiode arrays 23 is called “extending part 301”. The extending part 301 is provided over the entire length of the image sensor 22 in its longitudinal direction (main-scan direction) (i.e., across all the photodiode arrays 23). Although the extending dimension of the extending part 301 (the dimension in one short-hand direction (the dimension in the sub-scan direction)) is not particularly limited, it is preferable that the dimension be as long as possible.

The wavelength conversion member 3 is provided so that a part of this member can be overlapped on the image sensor 22 in an orientation where the side on which the substrate layer 31 is provided is close to the surface of the image sensor 22 (the light receiving surfaces 231 of the photodiode arrays 23) while the side on which the reflection layer 33 is provided is remote from the surface of the image sensor 22. The wavelength conversion member 3 may be fixed onto the surface of the image sensor 22 (the light receiving surfaces 231 of the photodiode arrays 23). For example, the wavelength conversion member 3 may adhere with adhesive or the like to the light receiving surfaces 231 of the photodiode arrays 23.

Alternatively, the wiring board 21 of the sensor substrate module 2 may be provided with a connector 24 for electrical connection to the outside. In this case, the configuration of the connector 24 is not particularly limited. Any of various publicly known connectors may be applied.

The body cover 13 is formed of a material having a high transmittance of radiation, and has a shape elongated in the longitudinal direction of the body frame 11. The specific configuration of the body cover 13 is not particularly limited. A configuration where the radiation detector 1a does not include the body cover 13 may be adopted.

### (Assembling Structure of Radiation Detector)

Here, an assembling structure of the radiation detector 1a is described. As shown in FIG. 4, the sensor substrate module 2 is housed and fixed in the sensor substrate module housing portion 111 of the body frame 11. The body cover 13 is provided on the upper side of the body frame 11.

When viewed from the longitudinal direction of the wiring board 21 (viewed from the main-scan direction), the sensor substrate module 2 is disposed so that one surface of the wiring board 21 that is the surface on which the image sensor 22 is provided can be oriented obliquely downward. That is, the image sensor 22 (photodiode arrays 23) is provided on the surface of the wiring board 21 opposite to the side that radiation enters. This sensor is provided inclined from the vertical direction (radiation incident direction). That is, the perpendicular (normal) of the surface of the wiring board 21 and the wavelength conversion member 3 is not parallel to the radiation incident direction (vertical direction) and is inclined by a predetermined degree instead. More specifically, when viewed from the longitudinal direction (viewed from the main-scan direction), the wiring board 21 is provided in an inclined manner where the adjacent long side (one edge part) is disposed upward and the remote long side (opposite edge part) is disposed downward. Accordingly, the surface (radiation incident surface) on the side of the substrate layer 31 of the wavelength conversion member 3 is oriented obliquely upward and inclined from the vertical direction (radiation incident direction).

Furthermore, in the vertical directional view, the extending part 301 of the wavelength conversion member 3 is disposed at a position where it is overlapped on the frame through-hole 112 provided in the body frame 11 (in FIG. 4, the position in a range indicated by symbol B). In the vertical directional view (when viewed from the radiation incident direction), the extending part 301 is not overlapped on the image sensor 22 (photodiode arrays 23). Note that in the vertical directional view (viewed from the radiation incident direction), the portions other than the extending part 301 are overlapped on the image sensor 22 (photodiode arrays 23). As described above, in the vertical directional view (viewed from the radiation incident direction), the wavelength conversion member 3 includes a portion that is overlapped on the photodiode arrays 23 and a portion that is not overlapped on the photodiode arrays 23. It is preferable that in the vertical directional view (viewed from radiation incident direction), the wiring board 21 and the photodiode arrays 23 be disposed at a position that is not overlapped on the frame through-hole 112 (a position out of the range indicated by symbol B in FIG. 4). The photodiode arrays 23 are provided at one end of the wiring board 21 in the short-hand direction, and are provided so that in the vertical directional view, the one end can be disposed on the side nearer to the frame through-hole 112. Accordingly, in the vertical directional view (viewed from radiation incident direction), the wiring board 21 and the photodiode arrays 23 may be provided at positions that are not overlapped on the frame through-hole 112 while the extending part 301 of the wavelength conversion member 3 can be provided on a position that is overlapped on the frame through-hole 112.

The body cover 13 is provided on the upper side of the body frame 11. The body cover 13 is made of a material having a high transmittance of radiation, and has a configuration elongated in the longitudinal direction (main-scan direction) of the body frame 11, for example. The body cover 13 is provided on the upper side of the body frame, thereby allowing foreign objects to be prevented from intruding into the body frame 11. A configuration where the radiation detector 1a does not include the body frame 11 may be adopted.

### (Operation of Radiation Detector)

Next, the operation of the radiation detector 1a is described. The radiation detector 1a is used in a manner where this detector is disposed to face the radiation source 51 at a predetermined distance so as to allow radiation emitted from the radiation source 51, not shown, to enter this detector (see FIG. 9). While the inspection object Q is caused to pass through the radiation source 51 and the radiation detector 1a, the radiation source 51 emits radiation to the inspection object Q and the radiation detector 1a detects the radiation having transmitted through the inspection object Q.

The radiation having entered the radiation detector 1a passes through the frame through-hole 112 of the body frame 11 and enters the wavelength conversion member 3. When the radiation enters the fluorescent layer 32 of the wavelength conversion member 3, this layer is excited to emit fluorescent light (visible light) according to the intensity of the incident radiation. That is, the incident radiation is converted by the fluorescent layer 32 into light having a wavelength detectable by the image sensor 22. The light receiving parts 232 of the photodiode arrays 23, which forms the image sensor 22, then converts (performs photoelectric conversion of) the fluorescent light emitted from the fluorescent layer 32 into an electric signal. In this case, reflection of the fluorescent light emitted from the fluorescent layer 32 by the reflection layer 33 increases the quantity of fluorescent light incident on the light receiving parts 232. Consequently, the detection sensitivity is improved.

The image sensor 22 outputs the electric signal generated through the photoelectric conversion by the light receiving parts 232 at a certain timing as a single-line signal of the radiation image signal (radiation image data). The radiation detector 1a continuously executes such an operation, which can generate and output the two-dimensional radiation image signal (radiation image data) that includes the internal information on the inspection object Q.

### (Operation Etc.)

In a first embodiment of the present invention, the wiring board 21, and the photodiode arrays 23, which form the image sensor 22, are not provided on the path where radiation enters the body frame 11 and reaches the wavelength conversion member 3. Members other than the wiring board 21 and the image sensor 22 (photodiode arrays 23) are not provided on the radiation path. Consequently, the radiation having entered the body frame 11 does not transmit through the wiring board 21, the image sensor 22 and the other members before reaching the wavelength conversion member 3. Such a configuration can improve the efficiency of detecting radiation while suppressing noise. That is, according to the configuration of allowing radiation having entered the body frame 11 to transmit through the wiring board 21 and the image sensor 22, the radiation is absorbed and scattered during transmission through the wiring board 21 and the image sensor 22, and the dose of radiation reaching the wavelength conversion member 3 is reduced. When the radiation is absorbed by the image sensor 22, noise is caused by ionization. On the contrary, according to the first embodiment of the present invention, the radiation having entered the body frame 11 does not transmit through the image sensor 22 until reaching the wavelength conversion member 3. Consequently, occurrence of noise can be suppressed at the image sensor 22. The reduction in dose of radiation reaching the wavelength conversion member 3 can be suppressed. Consequently, the efficiency of detecting radiation can be improved.

According to the first embodiment, the position on the fluorescent layer 32 at which the fluorescent light is actually emitted can be arranged close to the light receiving parts 232 of the photodiode arrays 23, which form the image sensor 22. The reason is as follows. The position at which the fluorescent layer 32 actually emits the fluorescent light varies according to the energy of the incident radiation. More specifically, when low-energy radiation is incident, the fluorescent light is prone to being emitted from a shallow position from the incident surface. When high-energy radiation is incident, the fluorescent light is prone to being emitted from a deep position from the incident surface. In general, the distribution of radiation energy has a continuous spectrum, and there are more low-energy components than high-energy components. Accordingly, the fluorescent light emitted from the fluorescent layer 32 is strong in proximity to the surface on the radiation incident side. In the embodiment of the present invention, between both the surfaces of the fluorescent layer 32, the surface on the radiation incident side, i.e., the surface on which the fluorescent light is strong is nearer to the image sensor 22 (the light receiving parts 232 of the photodiode arrays 23). Consequently, the efficiency of detecting the fluorescent light can be improved.

The wiring board 21 of the sensor substrate module 2 is arranged in an inclined manner so that the adjacent long side (the edge part on the side where the extending part 301 of the wavelength conversion member 3 is provided) can be disposed upward when viewed from the longitudinal direction (viewed from the main-scan direction). According to such as configuration, the position on the fluorescent layer 32 that the radiation actually enters can be arranged to be close to the image sensor 22. In view from the image sensor 22, the radiation is also allowed to enter a position immediately above the surface of the image sensor 22 (the light receiving surfaces 231 of the photodiode arrays 23). More specifically, the radiation having transmitted through the frame through-hole 112 is allowed to reach (enter) a position close to a range C of being overlapped on the light receiving parts 232 of the photodiode arrays 23 when viewed from the direction perpendicular to the surface of the image sensor 22 (the light receiving surfaces 231 of the photodiode arrays 23) (viewed from the direction of an arrow A in FIG. 4) or at least a part of the range C. That is, in comparison with the configuration where the surface of the wiring board 21 is perpendicular to the vertical direction, a range B overlapped on the frame through-hole 112 in the vertical directional view can be close to the range C overlapped on the light receiving parts 232 of the photodiode arrays 23 when viewed from the direction perpendicular to the surface of the image sensor 22 (viewed from the direction of the array A in FIG. 4). Alternatively, in the vertical directional view, at least a part of the range B overlapped on the frame through-hole 112 can reside in the range C overlapped on the light receiving parts 232 of the photodiode arrays 23 when viewed from the direction perpendicular to the surface of the image sensor 22. Consequently, the fluorescent light incident on the image sensor 22 (the light receiving parts 232 of the photodiode arrays 23) can be intensified, and the efficiency of detecting the fluorescent light can be improved. The inclination angle of the wiring board 21 is not particularly limited.

### Second Embodiment of Radiation Detector

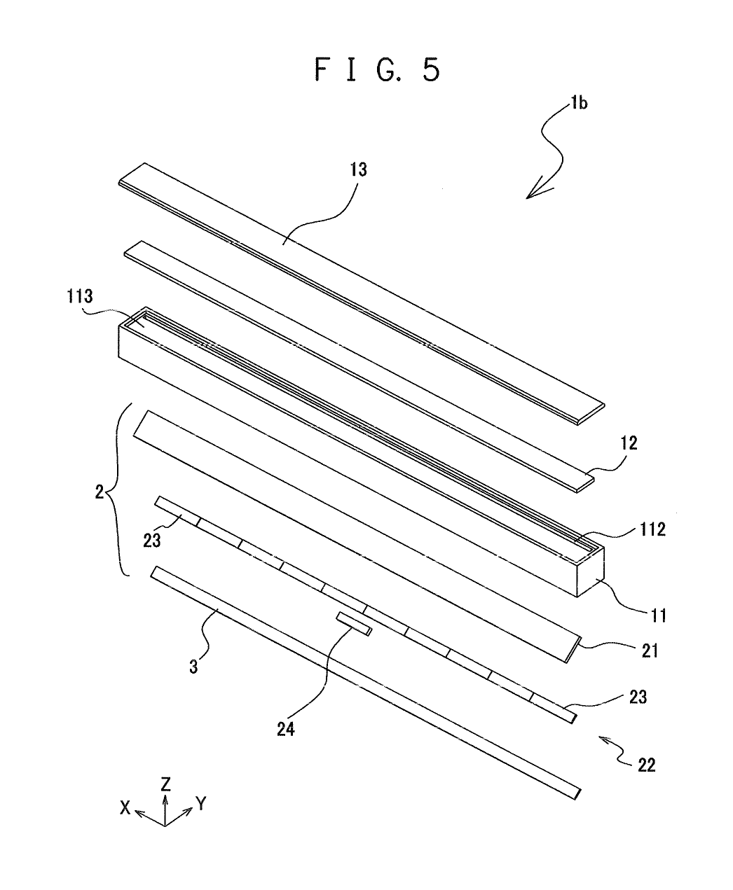

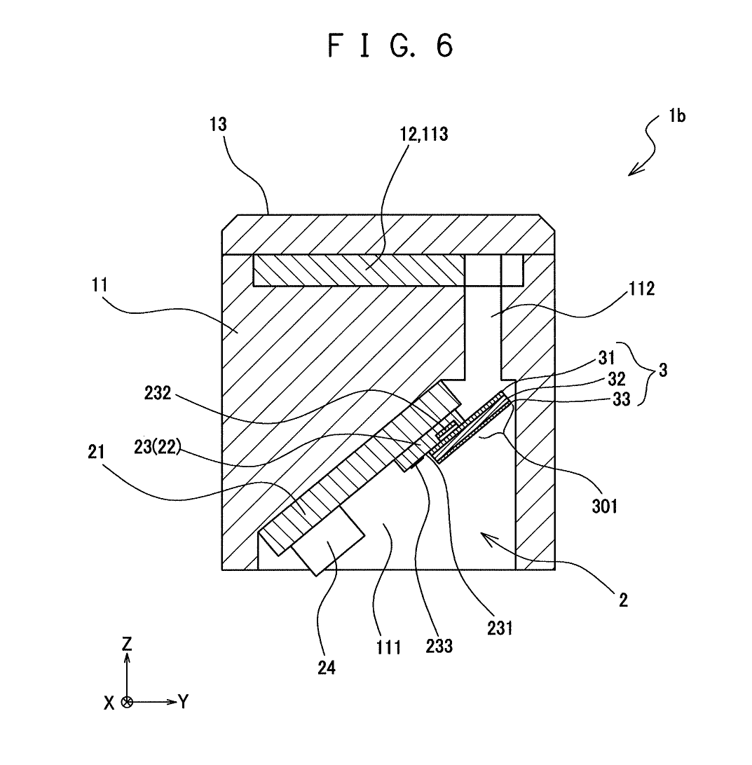

Next, a second embodiment of the present invention is described with reference to FIGS. 5 and 6. FIG. 5 is an exploded view schematically showing a configuration example of a radiation detector 1b according to the second embodiment. FIG. 6 is a sectional view schematically showing the configuration example of the radiation detector 1b according to the second embodiment, and shows a section taken along a plane perpendicular to the longitudinal direction (main-scan direction). Configurations common to those in the first embodiment are respectively assigned the same symbols, and the description thereof is omitted.

As shown in FIGS. 5 and 6, the radiation detector 1b according to the second embodiment includes a body frame 11, a sensor substrate module 2, a blocking member 12, and a body cover 13. The configurations of the sensor substrate module 2 and the body cover 13 are the same as those in the first embodiment. The body frame 11 may have the same configuration as that of the first embodiment except the configuration where a blocking member housing part 113 is provided. Note that the configuration in which the body frame 11 is not provided with the blocking member housing part 113 and which is the same as that of the first embodiment may be adopted. Alternatively, a configuration where the body cover 13 is not provided may be adopted. The blocking member 12 is made of, for example, a material having a low transmittance of radiation (a material at least having a transmittance of radiation lower than the body frame 11 has), such as titanium or lead. Although, the shape of the blocking member 12 is not particularly limited, FIGS. 5 and 6 show the example where the blocking member has a planar shape.

The blocking member 12 is disposed upper than the sensor substrate module 2 (close to one side on which the radiation is incident). In the second embodiment, the blocking member housing part is provided upper than the sensor substrate module housing portion 111 of the body frame 11. The blocking member 12 is housed in the blocking member housing part 113. For example, a groove or concave configuration that is open upward can be applied to the blocking member housing part 113. The blocking member 12 is disposed at a position that is overlapped on the wiring board 21 and the image sensor 22 but is not overlapped on the extending part 301 of the wavelength conversion member 3 in the vertical directional view (see FIG. 6).

According to such a configuration, radiation incident on the upper side of the body frame transmits through the frame through-hole 112 provided for the body frame 11 and reaches the wavelength conversion member 3. As the blocking member 12 is not overlapped on the extending part 301 of the wavelength conversion member 3, the radiation incident on the body frame 11 is not blocked by the blocking member 12 and reaches the wavelength conversion member 3. On the other hand, the blocking member 12 is provided so as to be overlapped on the image sensor 22. Consequently, the radiation incident on the body frame 11 is blocked so as not to reach the wiring board 21 and the image sensor 22. Therefore, such a configuration achieves the same effects as in the first embodiment. Moreover, by suppressing radiation incident on the image sensor 22, the noise can be further reduced. The blocking member 12 does not necessarily have the configuration of being overlapped on the entire wiring board 21 in the vertical directional view (viewed from radiation incident direction). For example, the blocking member 12 may be configured in any manner only if this member is overlapped on the portion of the wiring board 21 where the image sensor 22 (photodiode arrays 23) is provided. The blocking member 12 may have a configuration of being overlapped also on the portion of the wiring board 21 where the elements other than the wiring pattern and the image sensor 22 are mounted. As described above, the blocking member 12 may be overlapped on the entire wiring board 21 in the vertical directional view (viewed from radiation incident direction). Alternatively, this member may have an overlapped portion and a non-overlapped portion.

The blocking member 12 may have a configuration of being provided with portions having transmittances of radiation that are different from each other. For the sake of convenience of description, the portion having a high transmittance of radiation is called a transmitting part, and a portion having a low transmittance is called a blocking part. The blocking member 12 is disposed so that the blocking part can be overlapped on the image sensor 22 and the transmitting part can be overlapped on the frame through-hole 112 of the body frame 11 and the extending part 301 of the wavelength conversion member 3 in the vertical directional view. In this case, the transmitting part is formed to have a shape elongated in the longitudinal direction (main-scan direction). For example, a slit-shaped through-hole that is arranged through in the vertical direction and is elongated in the longitudinal direction (main-scan direction) can be applied as the transmitting part. Such a configuration can also achieve the same effects as described above.

### Third Embodiment

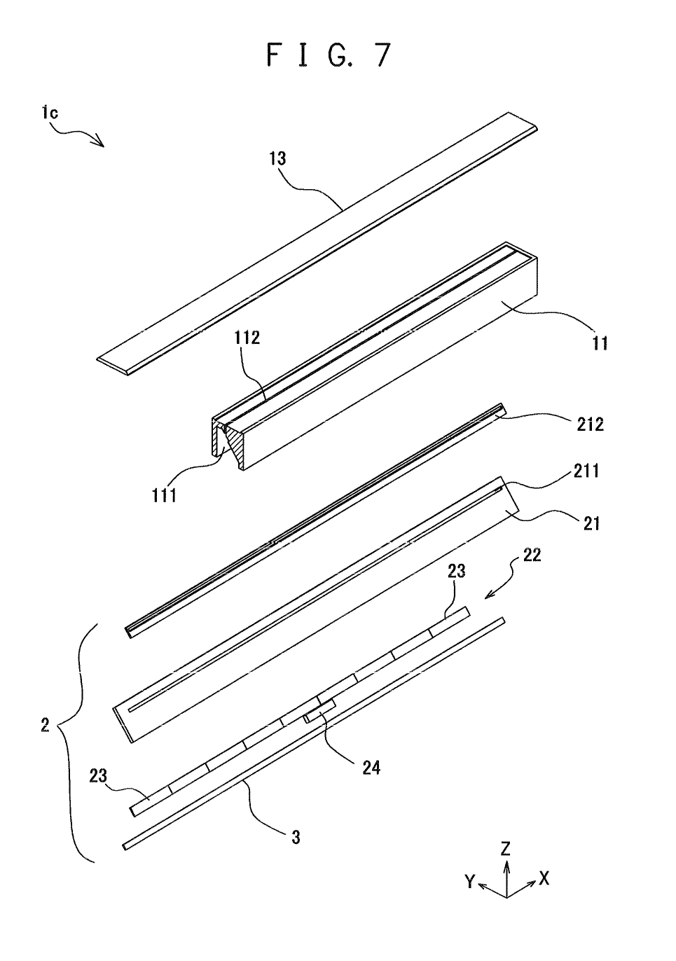

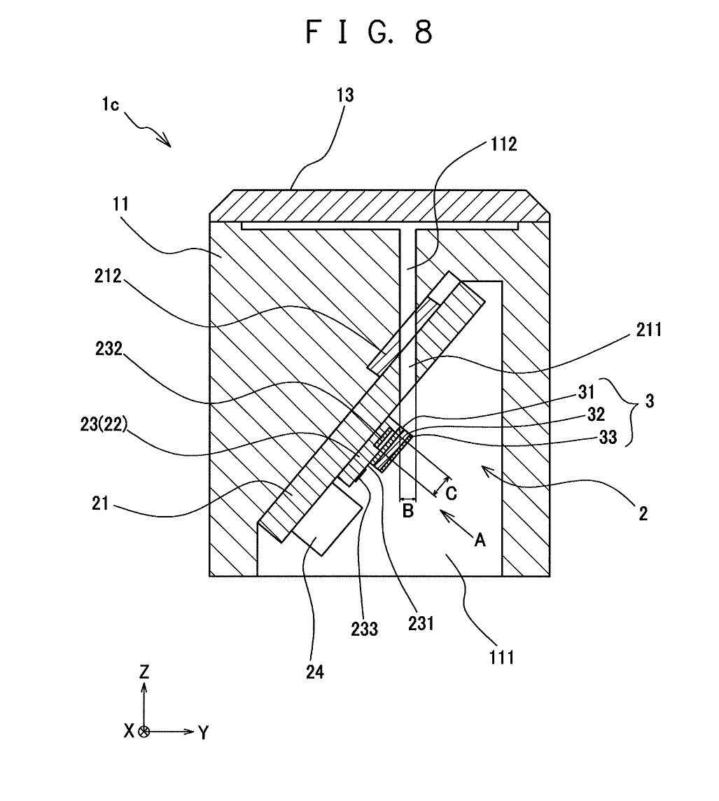

Next, a third embodiment of the present invention is described with reference to FIGS. 7 and 8. FIG. 7 is an exploded view schematically showing a configuration example of a radiation detector 1c according to the third embodiment. FIG. 8 is a sectional view schematically showing the configuration example of the radiation detector 1c according to the third embodiment, and shows a section taken along a plane perpendicular to the longitudinal direction (main-scan direction). Configurations common to those in the first embodiment are respectively assigned the same symbols, and the description thereof is omitted.

As shown in FIGS. 7 and 8, the wiring board 21 of the sensor substrate module 2 of the radiation detector 1c according to the third embodiment has an elongated shape (e.g., an elongated planar shape) as in the first embodiment. The wiring board 21 is disposed inclined from the vertical direction when viewed from the longitudinal direction of the wiring board 21 (viewed from the main-scan direction). On a surface of the wiring board 21 that is oriented downward, the linear-shaped image sensor 22 elongated in the longitudinal direction of the wiring board 21 (main-scan direction) is provided. On the surface of the image sensor 22, the wavelength conversion member 3 is provided. The configuration of the wavelength conversion member 3 may be the same as that in the first embodiment. At least a part thereof is provided so as to cover the light receiving parts 232 of the photodiode arrays 23, which form the image sensor 22.

Furthermore, the wiring board 21 is provided with a slit-shaped through-hole that is arranged through in the vertical direction and is elongated in the longitudinal direction. For the sake of convenience of description, the through-hole is called “circuit board through-hole 211”. The circuit board through-hole 211 has a function as a path of radiation. As described above, the linear-shaped image sensor 22 and the slit-shaped circuit board through-hole 211 are provided on the wiring board 21 so as to be parallel to each other. When viewed from the longitudinal direction of the wiring board 21, this wiring board 21 is provided in an inclined manner where a side in the short-hand direction (sub-scan direction) on which the circuit board through-hole 211 is provided is disposed upward and a side on which the image sensor 22 is provided is disposed downward. In this state, when viewed from the longitudinal direction of the wiring board 21, the axis (the center line extending in the penetrating direction) of the circuit board through-hole 211 extends in the vertical direction. Accordingly, the axis (the center line extending in the penetrating direction) of the circuit board through-hole 211 is inclined from the surface of the wiring board 21 instead of being perpendicular thereto.

On a surface (a surface oriented obliquely upward) opposite to the side of the wiring board 21 on which the image sensor 22 is provided, a blocking layer 212 is provided so as to surround the circuit board through-hole 211. The blocking layer 212 blocks radiation so as to prevent the radiation from reaching the lower side of the wiring board 21. As with the blocking member 12 in the second embodiment, a material having a low transmittance of radiation, such as titanium or lead, is applied as the blocking layer 212.

On the surface of the wiring board 21 oriented obliquely downward, the image sensor 22 (plurality of photodiode arrays 23) is provided, and the wavelength conversion member 3 is provided so as to cover the surface of the image sensor 22 (the light receiving parts 232 of the plurality of photodiode arrays 23).

Here, the positional relations between the circuit board through-hole 211, the wavelength conversion member 3 and the image sensor 22 are described with reference to FIG. 8. As shown in FIG. 8, when viewed from the longitudinal direction of the wiring board 21 and the wavelength conversion member 3 (viewed from the main-scan direction), the axis (penetrating direction) of the circuit board through-hole 211 is inclined from the surface of the wiring board 21, and approaches the image sensor 22 as the axis moves toward the surface on the side where the image sensor 22 is provided. At least a part of the wavelength conversion member 3 resides in the range B overlapped on the circuit board through-hole 211 when viewed from the axis direction of the circuit board through-hole 211 (viewed from the penetrating direction). In particular, it is preferable that at least a part of the range C of the wavelength conversion member 3 that is overlapped on the light receiving parts 232 when viewed from the direction perpendicular to the surface of the image sensor 22 (viewed from the direction of the arrow A) reside in the range B described above.

On the other hand, the image sensor 22 (photodiode arrays 23) is provided at a position that is not overlapped on the circuit board through-hole 211 in the vertical directional view (viewed from the axis direction of the circuit board through-hole 211). That is, the image sensor 22 is disposed so as not to reside in the range B overlapped on the circuit board through-hole 211 in the vertical directional view (outside of the range B).

According to such a configuration, radiation incident on the body frame 11 transmits through the frame through-hole 112 and the circuit board through-hole 211, and reaches the wavelength conversion member 3. Consequently, the radiation does not transmit through the photodiode arrays 23 and the other members until reaching the wavelength conversion member 3. In particular, according to the configuration provided with the circuit board through-hole 211, the radiation transmits through the circuit board through-hole 211, thereby allowing the radiation to reach the wavelength conversion member 3 without transmitting through the other portions (solid parts) of the wiring board 21. The radiation having transmitted through the circuit board through-hole 211 is then incident on a position directly above the light receiving parts 232 or adjacent thereto. Consequently, the wavelength conversion member 3 emits fluorescent light at the position directly above the light receiving parts 232 or adjacent thereto, thereby allowing the efficiency of detecting the fluorescent light by the image sensor 22 to be improved. Therefore, the same effects as in the first embodiment can be achieved.

According to the configuration where the blocking layer 212 is provided so as to surround the circuit board through-hole 211, the radiation is blocked by the blocking layer 212 so as not to enter the image sensor 22. Consequently, the noise can be reduced. It is preferable that the blocking layer 212 be provided so as to be overlapped on the entire image sensor 22 (all the photodiode arrays 23) in the vertical directional view. Such a configuration can improve the effect of suppressing entering of the radiation into the image sensor 22.

The blocking layer 212 may have a configuration of being provided only around the circuit board through-hole 211, or a configuration of being provided on the entire surface except the circuit board through-hole 211. The blocking layer 212 may have a configuration in close contact with the wiring board 21, or a configuration where this layer is provided above the wiring board 21 separated therefrom. Furthermore, the blocking layer 212 may have a configuration where this layer adheres to the wiring board 21 with adhesive or the like so as not to be separated, or a configuration where this layer is provided with screws, pins or the like in a separatable manner. That is, the blocking layer 212 may have any configuration only if the blocking layer 212 is provided in a range that is not overlapped on the circuit board through-hole 211 in the vertical directional view. The size of blocking layer 212 may be adjusted in conformity with the range to be irradiated with radiation.

Furthermore, such a configuration can improve the freedom of the arrangement positions of the photodiode arrays 23, which form the image sensor 22. That is, in the first embodiment and the second embodiment, the image sensor 22 is disposed at a certain position biased in the short-hand direction (sub-scan direction) and is close to one long side that is the edge part of the wiring board 21. On the contrary, in the third embodiment, the image sensor 22 is not necessarily disposed close to the one long side of the wiring board 21 of the image sensor 22.

FIGS. 7 and 8 show the configuration where the wavelength conversion member 3 is not provided with the extending part 301. Alternatively, as with the first embodiment and the second embodiment, a configuration may be adopted where the wavelength conversion member 3 is provided with the extending part 301. In this case, the extending part 301 may extend obliquely upward (toward the side on which the circuit board through-hole 211 is provided) from the image sensor 22, and at least a part of the extending part 301 may be overlapped on the circuit board through-hole 211 in the vertical directional view (viewed from the penetrating direction of the circuit board through-hole 211). In this case, the extending part 301 is only required to extend from the side surface of the image sensor 22, and does not necessarily extend from the one long side of the wiring board 21. That is, at least a part of the wavelength conversion member 3 may be provided to be overlapped on the surface of the image sensor 22 (in particular, the light receiving parts 232 of the photodiode arrays 23) and be overlapped on the circuit board through-hole 211 in the vertical directional view (viewed from the penetrating direction of the circuit board through-hole 211).

### <Radiation Detection Apparatus>

Next, the configuration example of a radiation detection apparatus 5 is described with reference to FIG. 9. FIG. 9 is a sectional view schematically showing a configuration example of the radiation detection apparatus 5. The radiation detection apparatus 5 includes the radiation source 51, and the radiation detector 1a,1b,1c according to each embodiment of the present invention. A radiation source that can emit radiation linearly elongated in the longitudinal direction of the radiation detector 1a,1b,1c is applied as the radiation source 51. The radiation source 51 may have any configuration only if this source can emit linear radiation, and is not limited to a specific configuration. The radiation source 51 and the radiation detector 1a,1b,1c are disposed to face each other with the conveyance path P for the inspection object Q interposed therebetween. The radiation emitted from the radiation source 51 transmits through the inspection object Q conveyed on the conveyance path P, and enters the radiation detector 1a,1b,1c. The radiation detector 1a,1b,1c performs the operation described above, thereby generating and outputting a two-dimensional radiation image signal (radiation image data) that includes the internal information on the inspection object Q.

Various embodiments of the present invention have been described above in detail. It should be noted that each embodiment described above only shows a specific example for implementing the present invention. The technical scope of the present invention is not limited to the embodiments described above. That is, the present invention may be implemented in various forms without departing from the technical spirit or main features thereof.

For example, each embodiment described above exemplifies the configuration where the image sensor is formed of the plurality of photodiode arrays. The image sensor is not limited to the configuration made of plurality of photodiodes. The image sensor may be any electronic component that can perform photoelectric conversion of fluorescent light (visible light) emitted from the fluorescent layer, such as a photoelectric conversion element.

The present invention can be effectively used for the radiation detector that includes the fluorescent layer and the image sensor that detects fluorescent light emitted from the fluorescent layer, and for the radiation detection apparatus that includes the radiation detector. The present invention can improve the efficiency of detecting radiation while suppressing noise.

What is claimed is:

1. A radiation detector, comprising:
a wavelength conversion part that includes a fluorescent layer that emits fluorescent light when radiation enters the fluorescent layer;
a photoelectric conversion part that converts the fluorescent light emitted from the fluorescent layer into an electric signal; and
a wiring board where the photoelectric conversion part is provided,
wherein the wavelength conversion part is provided on a surface on a side opposite to a side where the wiring board of the wavelength conversion part is provided, and is provided to include a portion overlapped on the photoelectric conversion part and a portion not overlapped on the photoelectric conversion part when viewed from a radiation incident direction.

2. The radiation detector according to claim 1,
wherein the photoelectric conversion part is provided on a surface of the wiring board opposite to a surface on which the radiation is incident.

3. The radiation detector according to claim 1,
wherein the wavelength conversion part includes a radiation incident surface on which the radiation is incident, and
the radiation incident surface is disposed inclined from the radiation incident direction.

4. The radiation detector according to claim 1,
wherein the photoelectric conversion part is linearly disposed.

5. The radiation detector according to claim 1,
wherein the photoelectric conversion part is disposed at an end of the wiring board.

6. The radiation detector according to claim 1,
wherein the wiring board has an elongated shape, and
the photoelectric conversion part is disposed along a longitudinal direction of the wiring board.

7. The radiation detector according to claim 1,
wherein the wavelength conversion part is disposed to include a portion that is not overlapped on the wiring board when viewed from the radiation incident direction.

8. The radiation detector according to claim 1, further comprising
a blocking member that blocks the radiation,
wherein the blocking member is disposed on a side of the photoelectric conversion part on which the radiation is incident, so as to be overlapped on the photoelectric conversion part when viewed from the radiation incident direction, and includes a part that is overlapped on the photoelectric conversion part of the wavelength conversion part and a part that is not overlapped on the photoelectric conversion part.

9. The radiation detector according to claim 8,
wherein the blocking member is disposed on a side of the wiring board where the radiation is incident, so as to be overlapped on the wiring board when viewed from the radiation incident direction.

10. A radiation detection apparatus, comprising:
a radiation source that generates radiation; and
the radiation detector according to claim 1.
